(19) United States
(12) Patent Application Publication
(10) Pub. No.: US 2002/0152353 A1
(43) Pub. Date: Oct. 17, 2002

(54) Method for dynamically determining optimal write speed of optical disk

(76) Inventors: Gang-Ming Fan, Taipei (TW); Yung-Yu Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/834,607

(22) Filed: Apr. 16, 2001

(51) Int. Cl. G06F 12/00

(52) U.S. Cl. 711/112; 713/320

(57) ABSTRACT

A method for dynamically determining optimal write speed of optical disk is proposed. The target beta value and the power limit of laser are determined firstly. The optimum power control process is taken and the optimal power is compared with the power limit. If the optimal power is larger than the power limit, the write speed is reduced and optimum power control process is taken until the optimal write speed is found.

### FIELD OF THE INVENTION

The present invention relates to a method for dynamically determining optimal write speed of optical disk, especially to a method for dynamically determining optimal write speed of optical disk, wherein the write speed is reduced if the optimal power is larger than the power limit, thus ensuring the write quality.

### BACKGROUND OF THE INVENTION

The optimum write power and the write strategy are important issues for compact disk recorder (CD-R). The conventional method for determining optimum write power and the write strategy adopts optimum power control (OPC) method with beta measurement. As shown in FIG. 1, this method comprises following steps:

Step 11 :checking whether the target beta value cannot be found after several optimum power control processes; if true, the optimum power control process has error and the step 17 is carried out; if false, the step 12 is carried out;

Step 12: using beta measurement method to find optimum write power;

Step 13: checking whether the optimum write power corresponding to the target beta value is found; if true, the optimum power control method is successful; if false, the step 14 is carried out;

Step 14: checking whether the beta value is smaller than the target beta value; if false, the laser power is decreased in step 19 and then back to step 11;

Step 15: increasing the laser power;

Step 16: checking whether the laser power is larger than the laser power limit of a writing laser diode; if true; the optimum power control process has error and the step 17 is carried out; if false, back to step 11.

Therefore, by setting the target beta value for the optical disks, the optimum write power for the optical disks can be defined. As the write speed of the compact disk recorder becomes more and more rapid, the 12-× speed, 16-× speed and even the 20-× speed is realized. The write power of the compact disk recorder is also increased. However, the recording layer of different recordable optical disks may have characteristics of great variances. The write powers for different recordable optical disks are also different, even though at the same write speed. Moreover, the compact disk recorder has restricted write power limit, some recordable optical disks may have problem to find target beta value (i.e., optimum write power) at high write speed. The recordable optical disks cannot be written or have unsatisfactory result at that write speed.

### SUMMARY OF THE INVENTION

It is the object of the present invention to provide a method for dynamically determining optimal write speed of optical disk, thus protecting the writing laser diode of CD-R and ensuring write quality.

To achieve above object, the present invention provides a method for dynamically determining optimal write speed of optical disk, comprising following steps:

(1) setting a target beta value;

(2) setting a power limit;

(3) The optimum power control process is taken and the optimal power is compared with the power limit; If the optimal power is larger than the power limit, the write speed is reduced and optimum power control process is taken until the optimal write speed is found.

### BRIEF DESCRIPTION OF DRAWING

FIG. 1 shows the flowchart of conventional optimum power control (OPC) method;

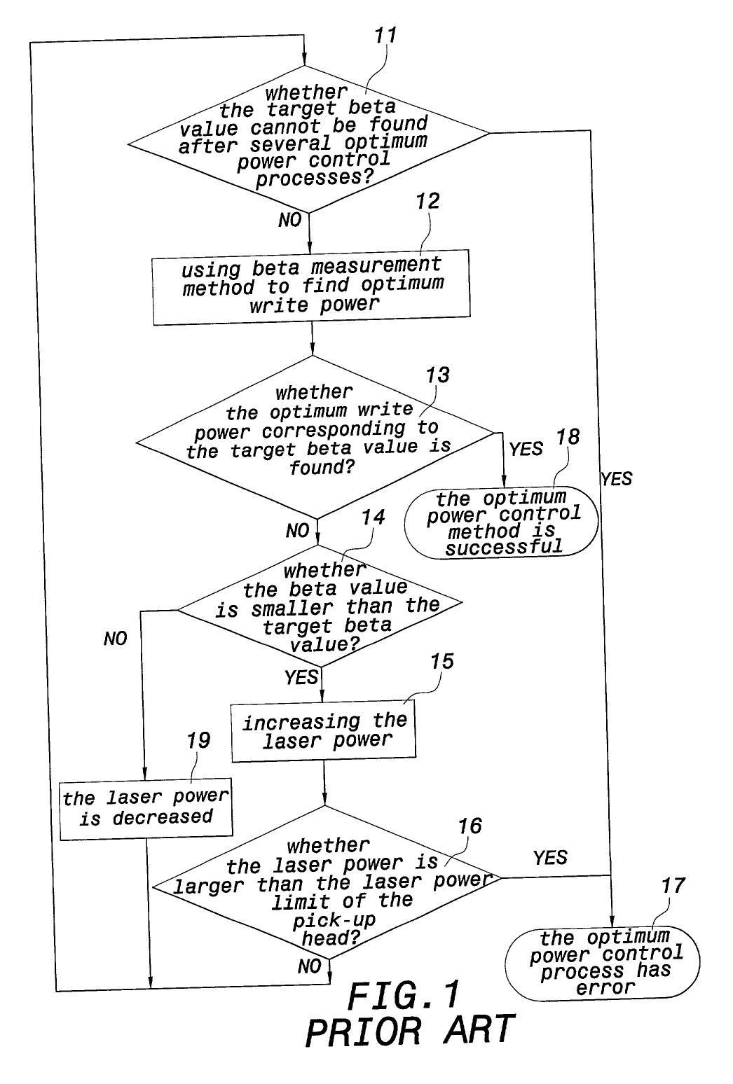

FIG. 2 shows the relationship of beta value with respect to the write power at various write speed;

FIG. 3 shows the flowchart of method for dynamically determining optimal write speed of optical disk according to the present invention.

### DETAILED DESCRIPTION OF THE INVENTION

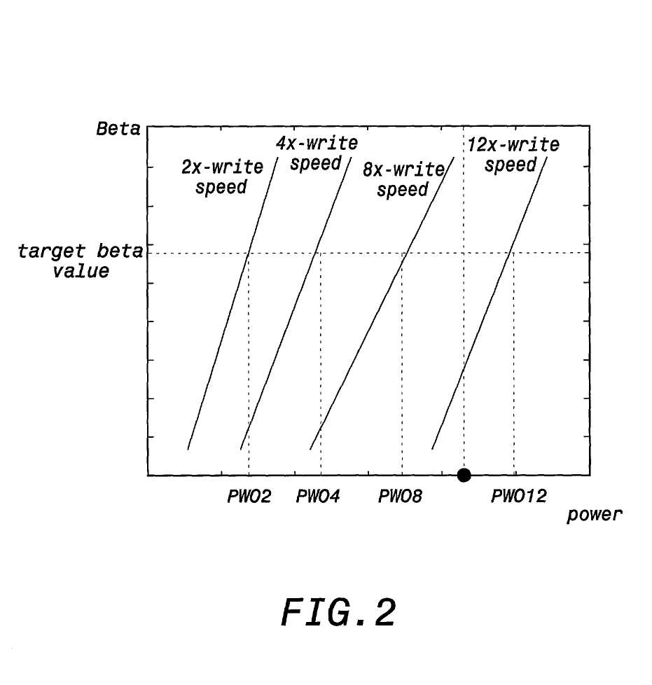

FIG. 2 shows the relationship of beta value with respect to the write power at various write speed (12-×, 8-×, 4-× and 2-×). As shown in this figure, the optimum write power PWO12 of 12-× write speed exceeds the power limit. The optimum write power PWO8 of 8-× write speed, PWO4 of 4-× write speed and PWO2 of 2-× write speed are within the power limit. Therefore, the compact disk recorder operates at high write speed requires higher write power. However, the life of the compact disk recorder is inversely proportional to the write power and write time. Therefore, it is precautious to prevent the compact disk recorder from operating at write power more than the power limit for any recording medium. To guarantee the write power being less than the power limit, the write power and, accordingly, the write speed is influenced and not optimal one.

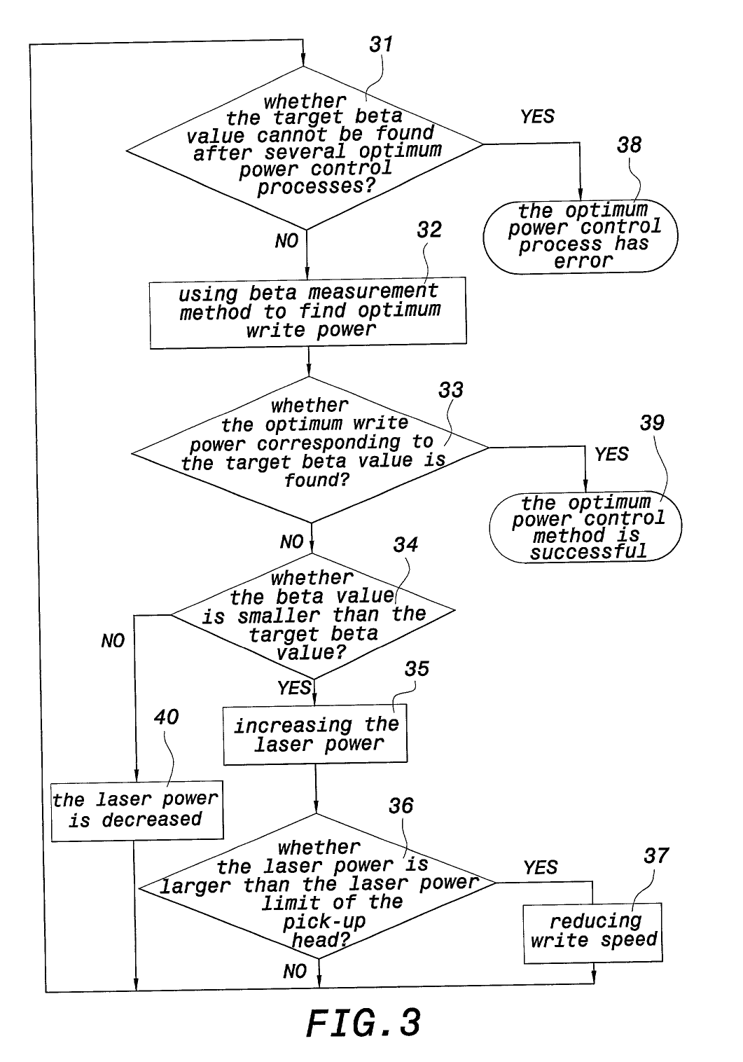

FIG. 3 shows the flowchart of method for dynamically determining optimal write speed of optical disk according to the present invention. The steps of the inventive method comprises following steps:

Steps 31: checking whether the target beta value cannot be found after several optimum power control processes; if true, the optimum power control process has error and the step 38 is carried out; if false, the step 32 is carried out;

Step 32: using beta measurement method to find optimum write power;

Step 33: checking whether the optimum write power corresponding to the target beta value is found; if true, the optimum power control method is successful; if false, the step 34 is carried out;

Step 34: checking whether the beta value is smaller than the target beta value; if false, the laser power is decreased in step 19 and then back to step 11;

Step 35: increasing the laser power;

Step 36: checking whether the laser power is larger than the laser power limit of the writing laser diode; if false, back to step 31;

Step 37: reducing the write speed and returning to step 31 until the optimal write speed is found.

To sum up, the method for dynamically determining optimal write speed of optical disk according to the present invention can find an optimal write speed while the write power is within the power limit. The writing quality is ensured.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A method for dynamically determining optimal write speed of optical disk, comprising following steps:
(a) checking whether a target beta value cannot be found after several optimum power control processes; if true, the optimum power control process has error;
(b) using beta measurement method to find optimum write power;
(c) checking whether the optimum write power corresponding to the target beta value is found; if true, the optimum power control method is successful; if false, the step (d) is carried out;
(d) checking whether the beta value is smaller than the target beta value; if false, the laser power is decreased and then back to step (a);
(e) increasing the laser power;
(f) checking whether the laser power is larger than the laser power limit of the writing laser diode; if false, back to step (a);
(g) reducing the write speed and returning to step (a) until the optimal write speed is found.

2. The method for dynamically determining optimal write speed of optical disk as in claim 1, wherein the target beta value in step (a) is optimized with respect to disk type and write speed.

3. The method for dynamically determining optimal write speed of optical disk as in claim 1, wherein the laser power limit of the writing laser diode in step (f) depends on specification of the writing laser diode.

4. The method for dynamically determining optimal write speed of optical disk as in claim 1, wherein the write speed in step (g) is reduced with reference to the allowable write speed of the optical disk recorder and the write speed selected by user.

5. The method for dynamically determining optimal write speed of optical disk as in claim 1, wherein the write speed selected by user included lowest write speed.
